(19) United States
(12) Patent Application Publication
(10) Pub. No.: US 2006/0042552 A1
(43) Pub. Date: Mar. 2, 2006

(54) Pet litter

(76) Inventor: William R. Venezio, Schenectady, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/928,988

(22) Filed: Aug. 30, 2004

(51) Int. Cl. A01K 29/00

(52) U.S. Cl. 119/171

(57) ABSTRACT

A pet litter composed of limestone (preferably, dolomitic limestone) particles in the size range of 0.0001 mm to 4.75 mm which clump readily when contacted by pet urine, particularly cat urine.

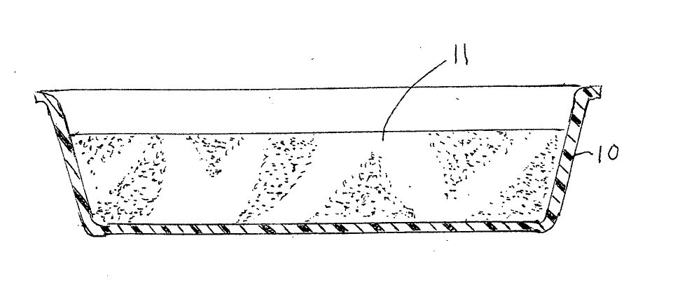

### BACKGROUND OF THE INVENTION

1. Field of the Invention

This invention relates to a pet litter, particularly for cats.

2. Prior Art

Most clumping pet litters on the market today use a bentonite clay to which a dry bonding agent is added to promote clumping.

In addition several patents have described the use of limestone particles in combination with various other materials in cat litter.

For example, U.S. Pat. No. 4,671,208 to Smith discloses a cat litter composition which combines ground clay, for its ability to absorb cat urine, with less expensive crushed dolomitic limestone, which acts to reduce odors by neutralizing acid in the cat urine. Smith states that while the limestone in its crushed state adsorbs liquids on the surface, the clay particles have a much greater tendency to absorb liquid. When the limestone is mixed with clay, any moisture adsorbed on the surface of the limestone particles is quickly absorbed by the clay, making it unnecessary to remove all the water from the crushed limestone before adding it to the ground clay. The clay particle size could be from 4/45 mesh (4.74 mm/0.355 mm), and preferably is 8/45 mesh (2.36 mm/0.355 mm). The dolomitic limestone particle size could be 8/45 mesh, and preferably is 16/25 mesh (1.18 mm/0.710 mm).

Johnson U.S. Pat. No. 4,465,019 discloses a pet litter having pieces of dried citrus pulp of a size to coat and adhere to the animal's feces, as well as to deodorize both feces and urine, and smaller “fines” which absorb the urine. In processing the citrus fruit, for the purpose of removing the soft, moist, slippery coating of squeezed citrus fruit, dolomitic limestone is added to the squeezed citrus fruit before it is cut into small pieces.

Stapley U.S. Pat. No. 4,355,593 cites limestone as one of many absorptive litter materials to which he adds a small amount of ground sagebrush particles and/or sagebrush oil for odor control purposes. In one embodiment, sagebrush particles 1.40 mm or smaller (passing through a Tyler No. 14 screen) and absorptive litter material particles of approximately the same size are pelletized by being extruded through a 1/16 to ½ inch diameter die and then cut into short lengths, typically 1/16 to ½ inch or more. In another embodiment, ground sagebrush and the absorptive litter material are combined after being separately formed into pellets. In yet another embodiment, sage brush oil is either absorbed or deposited on pellets of the absorptive litter material or on particles of that material which are pelletized later.

Various other pet litter formulations are disclosed in Nelson U.S. Pat. No. 5,062,383, Goss et al U.S. Pat. No. 5,359,961, Lander U.S. Pat. No. 4,471,717, Moore U.S. Pat. No. 5,961,968, Elazier-Davis et al U.S. Pat. No. 5,577,463, Lojek et al U.S. Pat. No. 4,676,196, and Greenberg U.S. Pat. No. 4,638,763.

### SUMMARY OF THE INVENTION

The present invention is directed to the use as a pet litter of limestone particles of a size to assure clumping when contacted by to pet urine.

Preferably, the present invention uses as a pet litter dolomitic limestone particles in the size range from 0.1 μm to 4.75 mm. Limestone is primarily calcium carbonate, CaCO₃; dolomite is primarily calcium magnesium carbonate, CaMg(CO₃)₂. Where limestone and dolomite occur together naturally the material is commonly known as dolomitic limestone.

A principal object of this invention is to provide a novel and advantageous particulate pet litter which clumps readily when exposed to pet urine.

Further objects and advantages of this invention will be apparent from the following detailed description of a presently preferred embodiment thereof, with reference to the accompanying drawing.

### BRIEF DESCRIPTION OF THE DRAWING

The single FIGURE of the drawing is a vertical section through a pet litter box in accordance with the present invention, consisting of a conventional open-topped pet litter receptacle and a bed of limestone particles in accordance with the present invention.

### DETAILED DESCRIPTION OF THE INVENTION

Before explaining the present invention in detail it is to be understood that the invention is not limited in its application to the particular arrangement shown and described since the invention is capable of other embodiments. Also, the terminology used herein is for the purpose of description and not of limitation.

In accordance with the preferred embodiment of this invention, dolomitic limestone is crushed, washed, dried and screened to pass only particles within the size range from 0.0001 mm (0.1 μm) to 4.75 mm. Preferably without additives, the limestone particle mix 11 is put in a conventional, urine-proof, open-topped receptacle 10. Together they make up what is commonly called a “litter box.”

The use of limestone particles in this size range as a pet litter, particularly a cat litter, is based on observation of a noticeable clumping effect when an acidic watery solution, such as cat urine, contacts a bed of such particles. The overall reaction when an acidic solution, such as per urine, is dripped onto ground limestone is as follows:
CaCo₃+H₂O^{acid}? CO_{2(g)}+Ca(OH)₂

It appears that the reaction product calcium hydroxide is primarily responsible for the clumping of the limestone particles that was observed. The carbon dioxide evolved from the reaction makes the reaction irreversible.

Under microscopic examination before the reaction, the limestone particles have a white powdery coating, presumably calcium carbonate, on the particle surfaces. Tests indicate that the above-specified chemical reaction takes place primarily in this coating because there is no significant change in the particle size as a result of the reaction. Bubbling of hydrogen dioxide gas is observed, taking place more vigorously on the smaller sized particles than on the larger ones within the size range previously specified herein. Clumping is more pronounced the smaller the limestone particle size, so for purposes of this invention, the smaller the better.

In addition to its advantageous clumping properties, the ground limestone of the present invention acts as an odor-fighting material, as recognized in the prior art.

Preferably, the cat litter material of the present invention consists essentially of ground limestone, as specified, with nothing else added. However, without departing from the teaching of this invention, one or more other materials may be included in the litter bed 11 to add color or absorb or mask the odor caused by pet urine, so long as these additional materials do not significantly diminish the clumping properties of the limestone particles.

### PRIOR ART STATEMENT

Smith U.S. Pat. No. 4,671,208 discloses a cat litter composition of ground dried clay and crushed limestone. The mixture may have from 40% clay-60% limestone to 90% clay-10% limestone. The clay preferably should have a particle size of 4/45 mesh, preferably 8/45 mesh, and the limestone could have a particle size of 8/45 mesh, preferably 16/25 mesh.

Johnson U.S. Pat. No. 4,465,019 discloses an animal litter material with cut and dried pieces of citrus pulp, preferably ⅛-⅜ inch in both length and width, as well as smaller “fines.” In preparing the material, dolomite limestone is added to squeezed citrus pulp to remove its soft, moist, slippery coating before the pulp is cut into small pieces.

Stapley U.S. Pat. No. 4,355,593 discloses sagebrush or sagebrush oil as an odor control agent on absorptive litter material, which may be a mineral (silica, limestone, bentonite, kaolin or diatomaceous earth) or fibrous organic(straw, corn cob pulp, peanut hulls or sugar cane stalks).

Nelson U.S. Pat. No. 5,062,383 discloses an animal litter composed of pulverized fuller's earth clay with water added to make its free moisture content 7%-25%.

Goss et al U.S. Pat. No. 5,359,961 discloses an animal litter having non-swelling clay and/or diatomaceous earth particles coated with a galactomannan gum, which may be guar gum, locust gum, or an ether derivate of either.

Lauder U.S. Pat. No. 4,471,717 discloses an animal litter having non-water wettable granular material (corn cob, wood or sawdust) which is treated with non-water wettable hydrophobic material (wax, paraffin, oil based paint, silicone, or polymeric material). The preferred embodiment is corn cob granules treated with wax or paraffin.

Moore U.S. Pat. No. 5,961,968 discloses adding alum to poultry litter to make its pH low enough to inhibit ammonia volatilization and to precipitate soluble phosphorus, thereby reducing its runoff.

Elazier-Davis et al U.S. Pat. No. 5,577,463 discloses an animal litter of extruded smectite clay (sodium bentonite, calcium bentonite, or mixtures of them) which is mixed before or after extrusion with a small percent of dry-mixed water-soluble adhesive (gum, cellulose ether, alginate, starch, and mixtures of them).

Lojek et al U.S. Pat. No. 4,676,196 discloses an animal litter with (1) a solid odor control material which may be basic, neutral or acidic, (2) depending on the odor control material, dried alfalfa or other chlorophyll containing grasses, baking, soda, finely divided paper, wood flour, sawdust, peat moss, cotton seed hulls, tomato pumice, and mixtures of them, (3) Portland cement or plaster of Paris, and (4) a binder (starches, gum, glues, and mixtures of them).

Greenberg U.S. Pat. No. 4,638,763 discloses anhydrous sodium sulfate as an additive to animal litters of mineral, cellulosic, or chlorophyll containing material. Other optional additives are citric acid, sodium chloride activated carbon granules, and germicidal agents.

1. The use as pet litter of a particulate bed consisting essentially entirely of limestone particles, comprising:
a. providing limestone which is ground to form limestone particles 0.0001 mm to 4.75 mm in size which clump readily when contacted by pet urine; and
b. placing said limestone particles in a pot litter receptacle.

2. The invention of claim 1 wherein said particles are dolomitic limestone.

3. A pet litter box comprising an open-topped receptacle and a pet litter bed consisting essentially of 0.0001 mm-4.75 mm sized limestone particles in said receptacle which clump readily when contacted by pet urine, wherein said pet litter bed does not contain additives which affect clumping of the limestone particles.

4. A pet litter box according to claim 3 wherein said particles are dolomitic limestone.

5. A litter bed for a pet litter box consisting essentially entirely of limestone particles 0.0001 mm to 4.75 mm in size which clump readily when contacted by pet urine, wherein materials other than limestone included in the litter bed do not diminish clumping of the limestone particles.

6. A method of preparing a pet litter box which comprises the steps of: reducing limestone to particles 0.0001 mm to 4.75 mm in size; and placing said limestone particles alone in an open-topped receptacle as the sole constituent of a litter bed therein.

7. The method of preparing a pet litter receptacle, comprising the steps of:
a. providing dolomitic limestone;
b. crushing said limestone to form ground limestone;
c. screening said ground limestone to pass only particles within the size range from 0.0001 mm to 4.75 mm, wherein the screening forms screened limestone particles;
d. placing said screened limestone particles in a pet litter receptacle as a sole constituent, wherein said particles clump when contacted with cat urine.

8. The method of claim 7, further comprising the steps of:
a. washing said ground limestone; and
b. drying said ground limestone.
